(19) United States
(12) Patent Application Publication
(10) Pub. No.: US 2025/0134261 A1
(43) Pub. Date: May 1, 2025

(54) MASSAGE CHAIR FRAME AND MASSAGE CHAIR

(71) Applicants: XIAMEN COMFORT SCIENCE&TECHNOLOGY GROUP CO., LTD, Fujian (CN); XIAMEN HEALTHCARE ELECTRONIC CO., LTD., Xiamen City (CN); COZZIA USA LLC, COVINA, CA (US)

(72) Inventors: Zhican PAN, Fujian (CN); Renjie YOU, Fujian (CN)

(21) Appl. No.: 18/926,644

(22) Filed: Oct. 25, 2024

(30) Foreign Application Priority Data
Oct. 27, 2023 (CN) 202311407740.2

(51) Int. Cl. A47C 7/40; A47C 1/024; A47C 7/14

(52) U.S. Cl. CPC A47C 7/40; A47C 1/024; A47C 7/14

(57) ABSTRACT

A massage chair frame and a massage chair are provided. The massage chair frame includes a bottom frame, a seat frame, a backrest frame, and a first drive mechanism. The seat frame is provided with a hinge point, the backrest frame includes a backrest portion and a protrusion arranged at a bottom of the backrest portion, and an end of the protrusion is hinged to the hinge point of the seat frame. The first drive mechanism is located below the hinge point and the backrest portion, to allow the backrest frame to rotate around the hinge point to an angle lower than the horizontal plane where the hinge point is located. The bottom frame is provided with a second drive mechanism connected to the seat frame to drive the seat frame to reciprocate on a guide rail structure of the bottom frame.

### CROSS-REFERENCE TO RELATED APPLICATION

Pursuant to 35 U.S.C. § 119 and the Paris Convention, this application claims the benefit of Chinese Patent Application No. 202311407740.2 filed on Oct. 27, 2023, the content of which is incorporated herein by reference.

### TECHNICAL FIELD

The present application relates to the field of massage technology, more particularly to a massage chair frame and a massage chair.

### BACKGROUND

The statements provided herein are merely background information related to the present application, and do not necessarily constitute any prior arts. The chair frame of the massage chair in the prior art generally includes a bottom frame, a seat frame, a backrest frame and a calf frame. In some cases, the seat frame and the backrest frame are fixed as an integral and can move relative to the bottom frame to achieve functions such as zero leaning against the wall or zero gravity, but in these cases, an angle between the seat frame and the backrest frame is fixed, usually greater than 90° but less than 180°, so that consumers cannot adjust the angle between the seat frame and the backrest frame when using these massage chairs. Some massage chairs can adjust the angle between the seat frame and the backrest frame, and the seat frame can move forward and backward, and can also be lifted or lowered by flipping, but cannot make the backrest frame fall backward to a state of negative angle, which is not convenient for the human body to stretch.

### SUMMARY

In view of the technical problem existing in the prior art, the present application provides a massage chair frame and a massage chair, which can not only adjust the angle between the backrest frame and the seat frame, but also allow the backrest frame to fall backward to a negative angle, to facilitate the human body to stretch.

To solve the above technical problem, a technical solution adopted by the present application is to provide a massage chair frame, which includes a bottom frame, a seat frame, a backrest frame, and a first drive mechanism. The seat frame is provided with a hinge point. The backrest frame includes a backrest portion and a protrusion arranged at a bottom of the backrest portion. An extension direction of the protrusion intersects with the extension direction of the backrest portion, and an end of the protrusion is hinged to the hinge point of the seat frame. One end of the first drive mechanism is hinged to the seat frame, and the other end of the first drive mechanism is configured to retractably push the backrest frame to drive the backrest frame to flip relative to the seat frame. The first drive mechanism is located below the hinge point and the backrest portion, to allow the backrest frame to rotate around the hinge point to an angle lower than a horizontal plane where the hinge point is located.

The bottom frame is provided with a guide rail structure, and the guide rail structure is arranged extending in a front-rear direction. The seat frame is provided with a roller group corresponding to the guide rail structure, and the roller group is slidably matched with the guide rail structure; the bottom frame is provided with a second drive mechanism, and the second drive mechanism is connected to the seat frame to drive the seat frame to reciprocate on the guide rail structure.

Further, a backrest rotation-shaft seat is provided at a top of a rear part of the seat frame, and the end of the protrusion is hinged to the backrest rotation-shaft seat, to allow the backrest portion to rotate to a position horizontal or arrive at a negative angle with the seat frame. A backrest fixed-end lug support is provided at a bottom of a front end of the seat frame, and the one end of the first drive mechanism is hinged to the backrest fixed-end lug support. A backrest movable-end lug support is provided at a bottom of the backrest frame, and the other end of the first drive mechanism is hinged to the backrest movable-end lug support.

Further, the backrest frame includes an upper frame body and a lower frame body, and the lower frame body includes a cross rod and a plurality of connecting parts distributed on the cross rod along a left-right direction. Each connecting part has a first side extending upward, and all the first sides are connected to the upper frame body to form the backrest portion. Each connecting part has a second side extending forward, and all the second sides constitute the protrusion. The backrest movable-end lug support is arranged on the cross rod.

Further, a bottom of the upper frame body corresponding to the first side of each connecting part is respectively connected with a latch box, and each latch box is respectively inserted with the first side of the corresponding connecting part.

Further, the guide rail structure includes a front guide rail and a rear guide rail, the front guide rail includes an ascending section having a higher front and a lower rear, and the rear guide rail is located behind the ascending section and is lower than a front end of the ascending section. The roller group includes a front roller and a rear roller distributed in sequence along the front-rear direction, the front roller is slidably matched with the front guide rail, and the rear roller is slidably matched with the rear guide rail.

Further, the front guide rail also includes a first extension section extending backward from a rear end of the ascending section. The rear guide rail includes a descending section having a lower front and a higher rear and a second extension section extending upward from the rear end of the descending section. The descending section is located above the first extension section. The descending section is in an inclined state, and the ascending section is in an arc shape.

Further, multiple guide rail structures are provided, and the multiple guide rail structures are distributed along the left-right direction.

Further, a flip angle of the backrest frame relative to the horizontal plane is in a range of 112°-188.5°. An angle of the seat frame relative to the horizontal plane that can be reached is in a range of 4°-36.5°. The first drive mechanism is a backrest push rod.

Furthermore, the massage chair frame also includes a calf frame and a third drive mechanism. The calf frame is hinged to the front end of the seat frame. One end of the third drive mechanism is hinged to the seat frame, and the other end of the third drive mechanism is configured to retractably push the calf frame to drive the calf frame to flip relative to the seat frame. The first drive mechanism is a backrest push rod. The second drive mechanism is a seat frame push rod, and a movable part of the seat frame push rod is hinged to the seat frame. The third drive mechanism is a calf push rod.

The present application further provides a massage chair, which includes the massage chair frame as described above.

Compared with the prior art, the present application has the following beneficial effects:
1. Since the bottom of the backrest frame is hinged to the seat frame, one end of the first drive mechanism is hinged to the seat frame, and the other end of the first drive mechanism is configured to retractably push the backrest frame to drive the backrest frame to flip relative to the seat frame. The first drive mechanism is located below the hinge point and the backrest portion, to allow the backrest frame to rotate around the hinge point to an angle lower than the horizontal plane where the hinge point is located. The bottom frame is provided with a guide rail structure, and the guide rail structure is arranged extending in the front-rear direction. The seat frame is provided with a roller group corresponding to the guide rail structure, and the roller group is slidably matched with the guide rail structure. The bottom frame is provided with a second drive mechanism, and the second drive mechanism is connected to the seat frame to drive the seat frame to reciprocate on the guide rail structure, so that the present application can not only adjust the angle between the backrest frame and the seat frame, but also make the backrest frame fall backward to a negative angle state, so as to facilitate the human body to perform muscle stretching movements.
2. The seat frame of the present application can realize forward and backward movement and flipping functions, so as to realize functions such as zero leaning against the wall or zero gravity. Therefore, the seat frame of the present application can realize multi-posture adjustment to adapt to diversified usage scenarios.

The present application is further described in detail below in conjunction with the accompanying drawings and embodiments. It should be noted that the massage chair frame and the massage chair of the present application are not limited to these embodiments.

### BRIEF DESCRIPTION OF DRAWINGS

FIG. 1 is a schematic diagram of an exploded view of a chair frame of the present application;

FIG. 2 is a schematic diagram of a three-dimensional structure of a bottom frame of the present application;

FIG. 3 is a partially enlarged schematic diagram of a combination of the bottom frame and a seat frame of the present application;

FIG. 4 is a partially enlarged schematic diagram of a combination of a backrest frame and the seat frame of the present application;

FIG. 5 is a partially enlarged schematic diagram of a combination of the seat frame and a calf frame of the present application that are fitted;

FIG. 6 is a schematic diagram of a three-dimensional structure of the chair frame of the present application in a lying state;

FIG. 7 is a schematic diagram of a three-dimensional structure of the chair frame of the present application in a stretched state;

FIG. 8 is a side view of the chair frame of the present application in a stretched state;

FIG. 9 is a schematic diagram of a three-dimensional structure of the chair frame of the present application in a zero-gravity state; and

FIG. 10 is a schematic diagram of a three-dimensional structure of the chair frame of the present application in a V-shaped state.

Reference signs in the figures are listed as follows: 1, backrest frame, 11, backrest fixed-end lug support, 12, backrest push rod, 13, latch box, 14, lower frame body, 141, cross rod, 142, first side, 143, second side, 15, backrest movable-end lug support, 16, upper frame body, 17, backrest pin, 18, backrest rotation-shaft seat, 21, calf frame, 22, calf lug support, 23, calf push rod, 24, calf anti-pinch lug support, 25, calf fixing lug support, 26, calf tension spring; 3, bottom frame, 31/37, rear guide rail, 32/36, front guide rail, 33, side frame, 34, front crossbeam, 35, seat frame fixing lug support, 38, rear crossbeam, 39, ascending section, 310, first extension section, 311, descending section, 312, second extension section, 41, seat frame, 42, seat frame sleeve, 43, front roller, 44, pin, 45, seat frame lug support, 46, seat frame push rod, 47, rear roller.

### DETAILED DESCRIPTION

In the present application, the terms “first”, “second”, “third”, etc. are only used to distinguish similar objects, rather than to describe a specific order or sequence, and cannot be understood as indicating or implying relative importance. In the description, the directions or positional relationships indicated by “upper”, “lower”, “left”, “right”, “front”, “back”, etc. are based on the directions or positional relationships shown in the drawings, which are only for the convenience of describing the present application, rather than indicating or implying that the device referred to must have a specific direction, be constructed and operated in a specific direction, and thus cannot be understood as limiting the protection scope of the present application. For ordinary technicians in this field, the specific meanings of the above terms in the present application can be understood according to the specific circumstances.

In addition, in the description of the present application, unless otherwise specified, the phrase “a/the plurality of” means two or more. In the description of the present application, unless otherwise clearly specified and limited, the terms “provided with”, “connected”, etc. should be understood in a broad sense. For example, “being connected” may be a fixed connection, a detachable connection, or an integral connection, a mechanical connection, an electrical connection, a direct connection, an indirect connection through an intermediate medium, or an internal communication of two components. For ordinary technicians in this field, the specific meanings of the above terms in the present application can be understood according to specific circumstances.

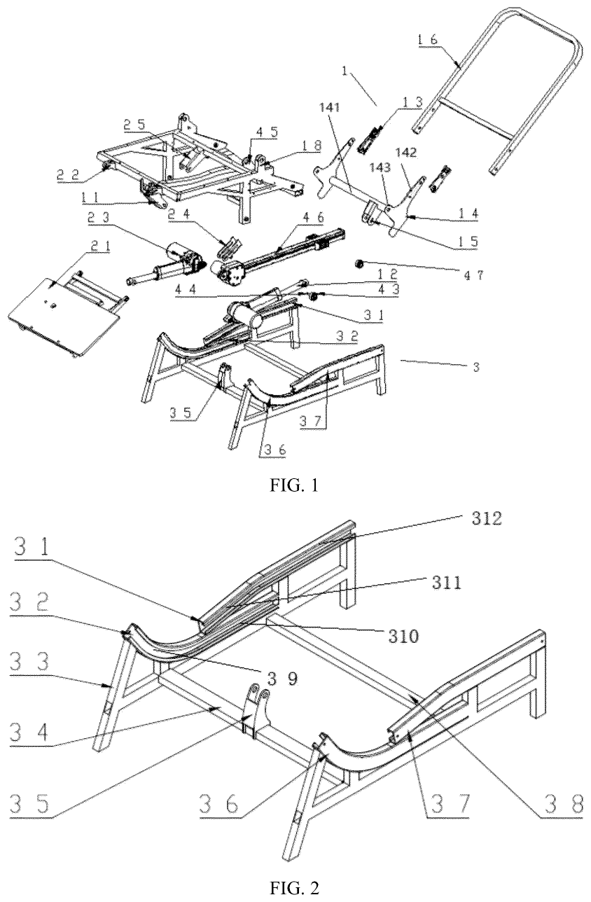

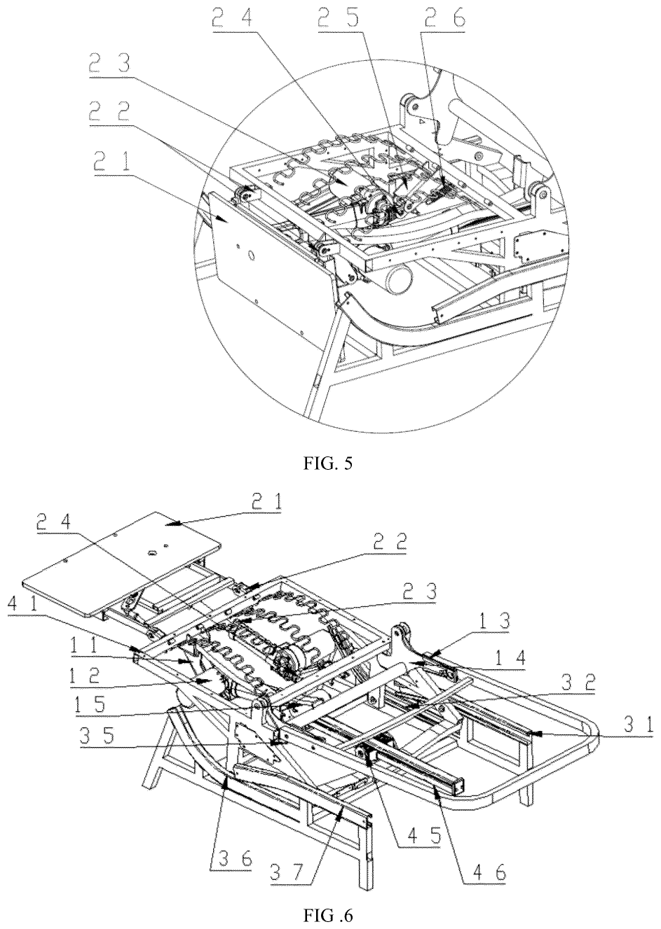

Referring to FIGS. 1 to 10, a massage chair frame provided in the present application includes a bottom frame 3, a seat frame 41, a backrest frame 1, a calf frame 21 and a first drive mechanism. The seat frame 41 is provided with a hinge point. The backrest frame 1 includes a backrest portion and a protrusion provided at the bottom of the backrest portion. An extension direction of the protrusion intersects with an extension direction of the backrest portion, and an end of the protrusion is hinged to the hinge point of the seat frame 41. One end of the first drive mechanism is hinged to the seat frame 41, and the other end of the first drive mechanism is configured to retractably push the backrest frame 1 to drive the backrest frame 1 to flip relative to the seat frame 41. The first drive mechanism is located below the hinge point and the backrest, allowing the backrest frame 1 to rotate around the hinge point to an angle lower than the horizontal plane where the hinge point is located. The bottom frame 3 is provided with multiple guide rail structures distributed along a left-right direction, and each guide rail structure is arranged extending in the front-rear direction. Particularly, the number of the guide rail structure is, but not limited to, two, and the two guide rail mechanisms are respectively located on the left and right sides of the seat frame 41. The seat frame 41 is provided with roller groups corresponding to each guide rail structure, and the roller groups are slidably matched with the guide rail structure. The bottom frame 3 is provided with a second drive mechanism, and the second drive mechanism is connected to the seat frame 41 to drive the seat frame 41 to reciprocate on the guide rail structure. The calf frame 21 is hinged to a front end of the seat frame 41, and the seat frame 41 is provided with a third drive mechanism. The third drive mechanism is connected to the calf frame 21 to drive the calf frame 21 to flip relative to the seat frame 41 around an axis extending along the left and right direction. Particularly, one end of the third drive mechanism is hinged to the seat frame 41, and the other end of the third drive mechanism is configured to retractably push the calf frame 21.

As shown in FIG. 1, a backrest rotation-shaft seat 18 is provided at the top of a rear part of the seat frame 41, and an end of the protrusion is hinged to the backrest rotation-shaft seat 18, so that the backrest portion is enabled to be rotated to a position that is horizontal or arrive at a negative angle with the seat frame 41 (i.e., the angle between the backrest portion and the seat frame 41 is greater than) 180°. Particularly, a backrest rotation-shaft seat 18 is provided at the left and right ends of the rear end of the seat frame 41, and the number of protrusions is two. The ends of the two protrusions are respectively connected to the two backrest rotation-shaft seats 18 by backrest pins. A backrest fixed-end lug support 11 is provided at the bottom of the front end of the seat frame 41, and one end of the first drive mechanism is hinged to the backrest fixed-end lug support 11. A backrest movable-end lug support 15 is provided at the bottom of the backrest frame 1, and the other end of the first drive mechanism is hinged to the backrest movable-end lug support 15.

As shown in FIG. 1, the backrest frame 1 includes an upper frame body 16 and a lower frame body 14. The lower frame body 14 includes a cross rod 141 and a plurality of connecting parts distributed on the cross rod 141 along the left-right direction. Each connecting part has a first side 142 extending upwards, and all the first sides 142 are connected to the upper frame body 16 to form the backrest portion. Each connecting part has a second side 143 extending forwards, and all the second sides 143 constitute the protrusion. The backrest movable-end lug support 15 is arranged on the cross rod 141. The first side 142 and the second side 143 together form substantially an L shape. Particularly, the number of connecting parts is two, and the two connecting parts are located at the left and right ends of the cross rod 141. The left and right ends at the bottom of the upper frame body 16 are respectively connected with a latch box 13 by screws, and the two latch boxes 13 are respectively inserted into the first sides 142 of the two connecting parts. The front end of the seat frame 41 is provided with two left and right calf lug supports 22, and the rear end of the calf frame 21 is hinged to the two calf lug supports 22. A calf tension spring 26 is also connected between the calf frame 21 and the seat frame 41. As shown in FIG. 2, each guide rail structure includes a front guide rail 32/36 and a rear guide rail 31/37, respectively. The front guide rail 32/36 is provided with an ascending section 39 which is high in the front and low in the rear. The rear guide rail 31/37 is located behind the ascending section 39 and is lower than the front end of the ascending section 39; the roller group includes a front roller 43 and a rear roller 47 that are sequentially distributed along the front-rear direction. The front roller 43 is slidably matched with the front guide rail 32/36, and the rear roller 47 is slidably matched with the rear guide rail 31/37. The front guide rail 32/36 also includes a first extension section 310 extending backward from the rear end of the ascending section 39, and the first extension section 310 is in horizontal. Particularly, the ascending section 39 may be, but not limited to, a concave arc shape, especially a circular arc shape.

The rear guide rail includes a descending section having a lower front and a higher rear and a second extension section extending upward from the rear end of the descending section. The descending section is in an inclined state and the ascending section is in an arc shape.

As shown in FIG. 2, the rear guide rail 31/37 includes a descending section 311 having a lower front and a higher rear and a second extension section 312 extending backward from the rear end of the descending section 311. The second extension section 312 is in horizontal, and the descending section 311 is particularly inclined, but not limited to this. The descending section 311 is located above the first extension section 310. The bottom frame 3 particularly includes two side frames 33 on the left and right and a front crossbeam 34 and a rear crossbeam 38 connected between the two side frames 33, and the two guide rail structures are respectively arranged on the two side frames 33.

In this embodiment, the first drive mechanism is a backrest push rod 12, and the second drive mechanism is a seat frame push rod 46, and a movable part of the seat frame push rod 46 is hinged to the seat frame 41. A front part of the bottom frame 3 is provided with a seat frame fixing lug support 35, particularly, the seat frame fixing lug support 35 is provided in the middle of the front crossbeam 34, and a main body of the seat frame push rod 46 is hinged to the seat frame fixing lug support 35. A rear part of the seat frame 41 is provided with a seat frame lug support 45, and the movable part of the seat frame push rod 46 is hinged to the seat frame lug support 45. The third drive mechanism is a calf push rod 23, one end of the calf push rod 23 is hinged to the seat frame, and the other end of the calf push rod 23 is hinged to the calf frame 21. Particularly, one end of the calf push rod 23 is hinged to a calf anti-pinch lug support 24, and the calf anti-pinch lug support 24 is connected to a calf fixing lug support 25 provided on the seat frame 41 through a pin shaft. The other end of the calf push rod 23 is hinged to a lug support provided on the calf frame 21.

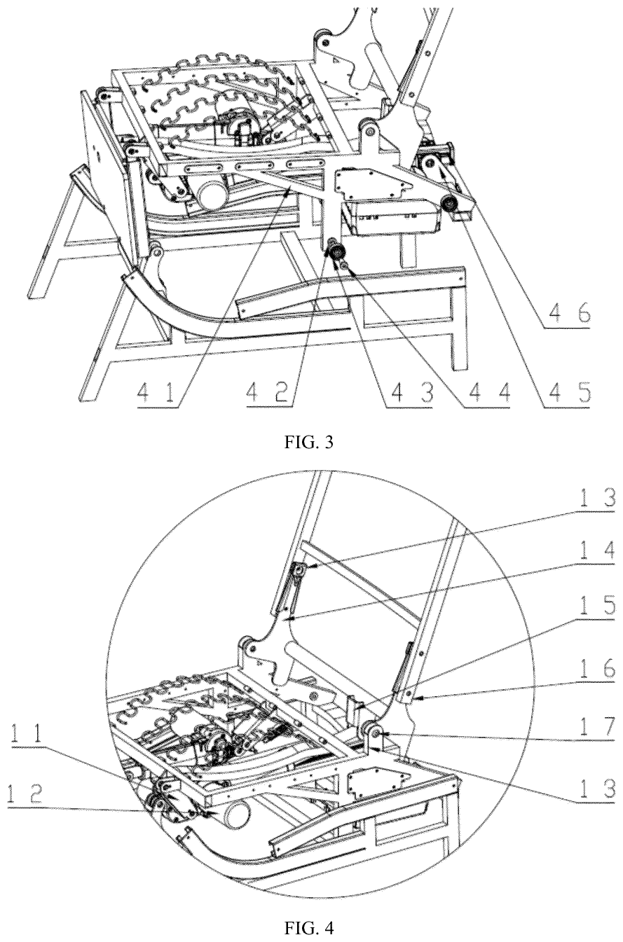

As shown in FIG. 3, the seat frame 41 is welded with a seat frame sleeve 42 at an installation position corresponding to each front roller 43 and rear roller 47, and the seat frame sleeve 42 is connected to the roller (i.e., the front roller 43 or the rear roller 47) through a pin 44.

In this embodiment, a flip angle of the backrest frame 1 relative to the horizontal plane is in a range of 112° to 188.5°. An angle of the seat frame 41 relative to the horizontal plane that can be reached is in a range of 4° to 36.5°.

The massage chair frame of the present application has the following working principle:

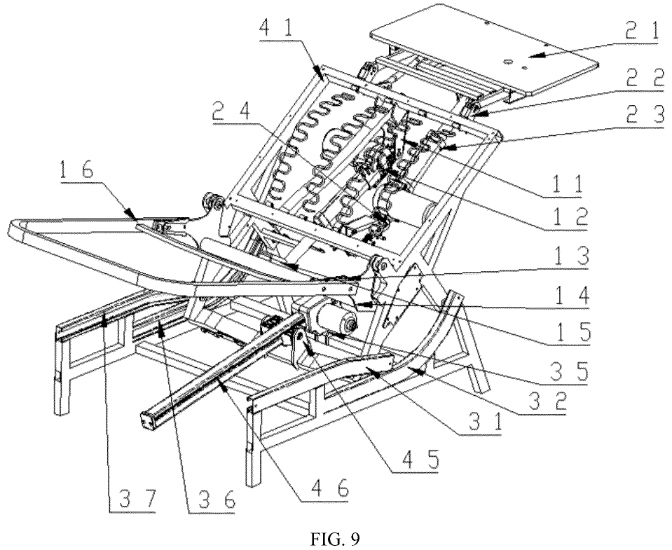

When the seat frame push rod 46 is retracted, the front roller 43 and the rear roller 47 move forward in the front guide rail 32/36 and the rear guide rail 31/37 respectively, so that the seat frame 41 moves forward first and then a lifting action is performed, as shown in FIG. 9, which is a state where the front end of the seat frame 41 is lifted in place.

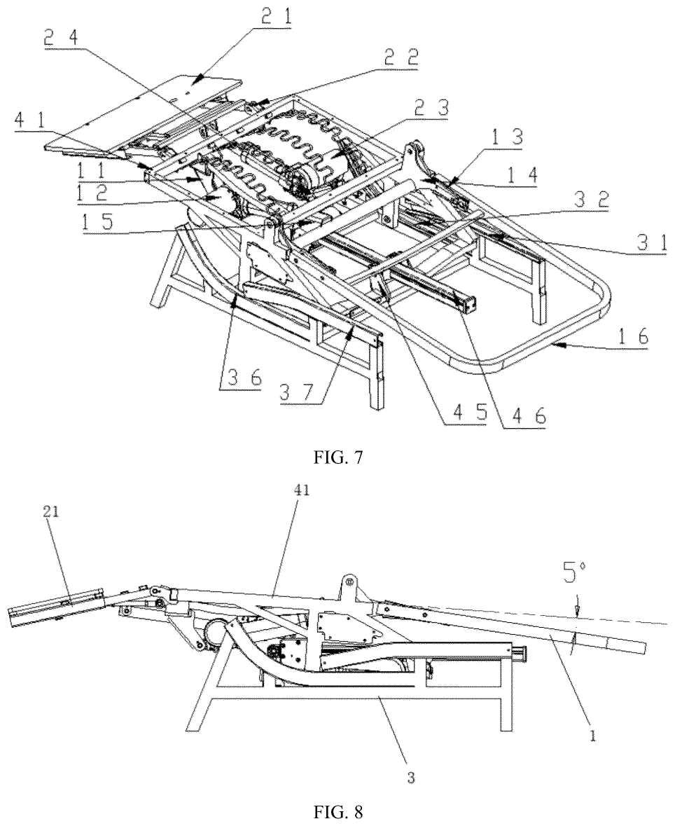

When the backrest push rod 12 is retracted, the backrest frame 1 is caused to make a circular motion around the backrest rotation-shaft seat 45, and the backrest frame 1 is driven to move, so that the backrest frame 1 is laid down, as shown in FIGS. 7 and 8.

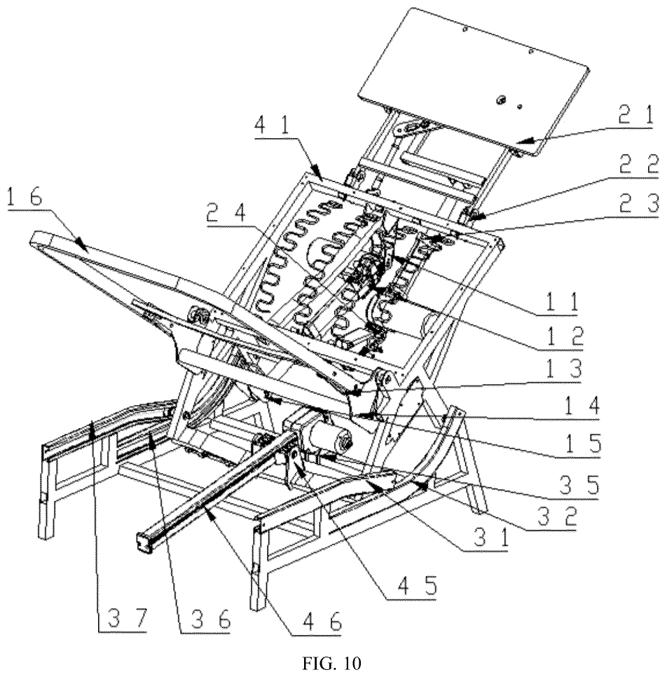

When the calf push rod 23 is pushed out, the calf frame 21 is pushed out and caused to make a circular motion around the calf lug support 22, so that the calf frame 21 is lifted, as shown in FIGS. 9 and 10. The calf frame 21 can rotate up to 101° relative to the horizontal plane.

The present invention can realize the adjustment of various postures by changing the angles between the backrest frame 1, the calf frame 21 and the seat frame 41 to adapt to diversified usage scenarios. Particularly, as shown in FIG. 6, the chair frame is in the lying state. Before forming the lying state, the seat frame 41 will first move forward a distance to keep the backrest frame 1 close to the wall at all times, and then the angles of the calf frame 21, the backrest frame 1, and the seat frame 41 are changed in combination, to allow the chair frame to arrive at the lying state, which greatly increases the comfort. As shown in FIGS. 7 and 8, the chair frame is in the stretched state. When switching the chair frame to the stretched state, the seat frame 41 will first move forward a distance to ensure that the chair frame is close to the wall, and then the angles of the calf frame 21, the backrest frame 1, and the seat frame 41 are changed in combination, to allow the seat frame 41 and the backrest frame 1 to form a negative angle, which enables the human body curve to form an anti-arch, to achieve the effect of stretching. As shown in FIG. 8, the chair frame is in the zero-gravity state. After the seat frame 41 is slid forward into place, the backrest frame 1 is in a reverse back state, and the calf frame 21 is horizontally lifted, forming an effect of simulating a zero-gravity environment. As shown in FIG. 10, the chair frame is in the V-shaped state. After the seat frame 41 is slid forward into place, the angle between the backrest frame 1 and the seat frame 41 changes to the minimum, and the calf frame 21 is fully unfolded, so that the chair frame, as a whole, forms a V shape, simulating the V-shaped pose in yoga poses, achieving the effects of enhancing ligament toughness and eliminating leg fat.

A massage chair of the present application includes the massage chair frame as described above. For the structure and working principle of the massage chair frame, references may be made to the previous description, which will not be repeated here.

In the massage chair frame and the massage chair of the present application, the uninvolved parts are the same as the prior art and can be implemented according to the prior art.

The above embodiments are only used to further illustrate the massage chair frame and the massage chair of the present application, but the present application is not limited to the above embodiments. Any simple modifications, equivalent variations and modifications made to the above embodiments according to the technical essence of the present application shall fall within the protection scope of the technical solutions of the present application.

1. A massage chair frame, comprising:
a bottom frame, having a guide rail structure extending in a front-rear direction;
a seat frame, having:
a roller group, corresponding to the guide rail structure, and slidably matched with the guide rail structure;
a hinge point;
a backrest frame, comprising:
a backrest portion; and
a protrusion, arranged at a bottom of the backrest portion, wherein an extension direction of the protrusion intersects with an extension direction of the backrest portion, and an end of the protrusion is hinged to the hinge point of the seat frame; and
a first drive mechanism, having one end being hinged to the seat frame, and another end being configured to retractably push the backrest frame to drive the backrest frame to flip relative to the seat frame,
wherein the first drive mechanism is located below the hinge point and the backrest portion, to allow the backrest frame to rotate around the hinge point to an angle lower than a horizontal plane where the hinge point is located; and
wherein the bottom frame is provided with a second drive mechanism, and the second drive mechanism is connected to the seat frame to drive the seat frame to reciprocate on the guide rail structure.

2. The massage chair frame according to claim 1, wherein
a backrest rotation-shaft seat is correspondingly provided at a top of a rear part of the seat frame, and the end of the protrusion is hinged to the backrest rotation-shaft seat to allow the backrest portion to rotate to a position horizontal or to arrive at a negative angle with the seat frame;
a backrest fixed-end lug support is provided at a bottom of a front end of the seat frame, and the one end of the first drive mechanism is hinged to the backrest fixed-end lug support; and
a backrest movable-end lug support is provided at a bottom of the backrest frame, and the another end of the first drive mechanism is hinged to the backrest movable-end lug support.

3. The massage chair frame according to claim 2, wherein
the backrest frame comprises an upper frame body and a lower frame body, and the lower frame body comprises a cross rod and a plurality of connecting parts distributed on the cross rod along a left-right direction,
each connecting part has a first side extending upward, and all first sides of the plurality of connecting parts are connected to the upper frame body to form the backrest portion, and each connecting part has a second side extending forward, and all second sides of the plurality of connecting parts constitute the protrusion; and
the backrest movable-end lug support is arranged on the cross rod.

4. The massage chair frame according to claim 3, wherein
a bottom of the upper frame body corresponding to the first side of each connecting part is respectively connected with a latch box, and each latch box is respectively inserted with the first side of a corresponding connecting part.

5. The massage chair frame according to claim 1, wherein
the guide rail structure comprises a front guide rail and a rear guide rail, the front guide rail comprises an ascending section having a higher front and a lower rear, and the rear guide rail is located behind the ascending section and is lower than a front end of the ascending section; and
the roller group comprises a front roller and a rear roller distributed in sequence along the front-rear direction, the front roller is slidably matched with the front guide rail, and the rear roller is slidably matched with the rear guide rail.

6. The massage chair frame according to claim 5, wherein
the front guide rail further comprises a first extension section extending backward from a rear end of the ascending section,
the rear guide rail comprises a descending section having a lower front and a higher rear and a second extension section extending upward from a rear end of the descending section, and the descending section is located above the first extension section; and
the descending section is in an inclined state, and the ascending section is in an arc shape.

7. The massage chair frame according to claim 1, wherein
multiple guide rail structures are provided, and the multiple guide rail structures are distributed along a left-right direction.

8. The massage chair frame according to claim 1, wherein
a flip angle of the backrest frame relative to the horizontal plane is in a range of 112°-188.5°; and
an angle of the seat frame relative to the horizontal plane that can be reached is in a range of 4°-36.5°.

9. The massage chair frame according to claim 1, further comprising a calf frame and a third drive mechanism,
wherein the calf frame is hinged to a front end of the seat frame, one end of the third drive mechanism is hinged to the seat frame, and another end of the third drive mechanism is configured to retractably push the calf frame to drive the calf frame to flip relative to the seat frame;
the first drive mechanism is a backrest push rod, the second drive mechanism is a seat frame push rod, and a movable part of the seat frame push rod is hinged to the seat frame; and
the third drive mechanism is a calf push rod.

10. A massage chair, comprising:
a massage chair frame, comprising:
a bottom frame, having a guide rail structure extending in a front-rear direction;
a seat frame, having:
a roller group, corresponding to the guide rail structure, and slidably matched with the guide rail structure;
a hinge point;
a backrest frame, comprising:
a backrest portion; and
a protrusion, arranged at a bottom of the backrest portion, wherein an extension direction of the protrusion intersects with an extension direction of the backrest portion, and an end of the protrusion is hinged to the hinge point of the seat frame; and
a first drive mechanism, having one end being hinged to the seat frame, and another end being configured to retractably push the backrest frame to drive the backrest frame to flip relative to the seat frame,
wherein the first drive mechanism is located below the hinge point and the backrest portion, to allow the backrest frame to rotate around the hinge point to an angle lower than a horizontal plane where the hinge point is located; and
wherein the bottom frame is provided with a second drive mechanism, and the second drive mechanism is connected to the seat frame to drive the seat frame to reciprocate on the guide rail structure.

11. The massage chair according to claim 10, wherein
a backrest rotation-shaft seat is correspondingly provided at a top of a rear part of the seat frame, and the end of the protrusion is hinged to the backrest rotation-shaft seat to allow the backrest portion to rotate to a position horizontal or to arrive at a negative angle with the seat frame;
a backrest fixed-end lug support is provided at a bottom of a front end of the seat frame, and the one end of the first drive mechanism is hinged to the backrest fixed-end lug support; and
a backrest movable-end lug support is provided at a bottom of the backrest frame, and the another end of the first drive mechanism is hinged to the backrest movable-end lug support.

12. The massage chair according to claim 11, wherein
the backrest frame comprises an upper frame body and a lower frame body, and the lower frame body comprises a cross rod and a plurality of connecting parts distributed on the cross rod along a left-right direction,
each connecting part has a first side extending upward, and all first sides of the plurality of connecting parts are connected to the upper frame body to form the backrest portion, and each connecting part has a second side extending forward, and all second sides of the plurality of connecting parts constitute the protrusion; and
the backrest movable-end lug support is arranged on the cross rod.

13. The massage chair according to claim 12, wherein
a bottom of the upper frame body corresponding to the first side of each connecting part is respectively connected with a latch box, and each latch box is respectively inserted with the first side of a corresponding connecting part.

14. The massage chair according to claim 10, wherein
the guide rail structure comprises a front guide rail and a rear guide rail, the front guide rail comprises an ascending section having a higher front and a lower rear, and the rear guide rail is located behind the ascending section and is lower than a front end of the ascending section; and
the roller group comprises a front roller and a rear roller distributed in sequence along the front-rear direction, the front roller is slidably matched with the front guide rail, and the rear roller is slidably matched with the rear guide rail.

15. The massage chair according to claim 14, wherein
the front guide rail further comprises a first extension section extending backward from a rear end of the ascending section,
the rear guide rail comprises a descending section having a lower front and a higher rear and a second extension section extending upward from a rear end of the descending section, and the descending section is located above the first extension section; and
the descending section is in an inclined state, and the ascending section is in an arc shape.

16. The massage chair according to claim 10, wherein
multiple guide rail structures are provided, and the multiple guide rail structures are distributed along a left-right direction.

17. The massage chair according to claim 10, wherein
a flip angle of the backrest frame relative to the horizontal plane is in a range of 112°-188.5°; and
an angle of the seat frame relative to the horizontal plane that can be reached is in a range of 4°-36.5°.

18. The massage chair according to claim 10, further comprising a calf frame and a third drive mechanism,
wherein the calf frame is hinged to a front end of the seat frame, one end of the third drive mechanism is hinged to the seat frame, and another end of the third drive mechanism is configured to retractably push the calf frame to drive the calf frame to flip relative to the seat frame;
the first drive mechanism is a backrest push rod, the second drive mechanism is a seat frame push rod, and a movable part of the seat frame push rod is hinged to the seat frame; and
the third drive mechanism is a calf push rod.
